(19) United States
(12) Patent Application Publication
(10) Pub. No.: US 2011/0305343 A1
(43) Pub. Date: Dec. 15, 2011

(54) Method and system decoding audio data with selective power control

(75) Inventors: Kang Eun Lee, Hwaseong-si (KR); Do-Hyung Kim, Hwaseong-si (KR); Chang Yong Son, Gunpo-si (KR)

(73) Assignee: SAMSUNG ELECTRONICS CO., LTD., Suwon-si (KR)

(21) Appl. No.: 13/067,530

(22) Filed: Jun. 7, 2011

(30) Foreign Application Priority Data
Jun. 8, 2010 (KR) 10-2010-0053940

(51) Int. Cl. G10L 21/00; H04R 5/00

(52) U.S. Cl. 381/22; 704/500

(57) ABSTRACT

Provided is an audio data decoding system and method that may selectively transfer compressed audio data from a top system to at least one audio input buffer of a separately provided and/or separately power management controlled subsystem, restore the compressed audio data to digital pulse code modulation (PCM) data using an audio decoding unit of the subsystem, convert the digital PCM data to analog PCM data or an audio output signal, and output the converted audio output signal.

### CROSS-REFERENCE TO RELATED APPLICATIONS

This application claims the priority benefit of Korean Patent Application No. 10-2010-0053940, filed on Jun. 8, 2010, in the Korean Intellectual Property Office, the disclosure of which is incorporated herein by reference.

### BACKGROUND

1. Field

One or more embodiments relate to a method and system decoding audio data with provision of audio data to an audio decoder based upon selectively different power modes.

2. Description of the Related Art

Current multimedia devices may provide a playback function with respect to compressed audio data. The audio playback function is typically intimately associated with a plurality of modules or operations within the corresponding multimedia device. The multimedia device may be a digital audio playback device, such as MP3 player, and may be device that is capable of performing multiple other functions in addition to the playback function.

In the case of general audio data compression, each channel of an audio signal may be separately encoded and stored, such that a decoder separately decodes each channel and outputs the resultant digital PCM data to a CODEC, which converts the digital PCM data to analog PCM data. Alternatively, instead of separately compressing each channel of a multi-channel audio data, the compression of the audio signal may include compressing all of the channels, or select channels, to a down-mixed mono or stereo signal. This down-mixing of the audio signal is performed by comparing like channel signals and outputting a respective single signal with the comparison information, so a decoder can decode the single channel back to the multi-channel signal by applying the comparison information to the single signal, which is referred to as up-mixing. With plural stages of down-mixing, all channels in the multi-channel signal can be down-mixed to the mono or stereo signals, and stored or transmitted for subsequent reproduction by a decoder. The transmitted comparison information may be stored or transmitted as spatial information.

Currently, to effectively restore compressed audio data, the compressed audio data may be stored or transmitted as any of the widely used MP3 format, advanced audio coding (AAC) format, window media audio (WMA) format, and the like, and a reproducing device may read the compressed audio data, decode the compressed audio data, which may include the up-mixing operation, and output the restored audio data as analog and/or digital pulse code modulation (PCM) data. A CODEC may be used for converting the digital PCM data to the audio PCM data. However, with this approach, a relatively large amount of processing power may be necessary to restore the compressed audio data. The large amount of processing power may result in reduction of power for alternative operations of the reproducing device, and may undesirably reduce the available power reserves, such as when the reproducing device is a mobile device and relies upon a fixed amount of energy, e.g., limited by one or more batteries.

A large consumer of energy is the processor of the reproducing device.

FIG. 1 illustrates a configuration of a conventional audio data decoding apparatus, including a top system 100, an audio input buffer 120, and an audio codec unit 130.

The top system 100 includes a central processing unit (CPU), a synchronous dynamic random access memory (SDRAM) for storing received compressed audio data, and an audio decoder to decode the compressed audio data. The audio decoding apparatus separately operates an audio input buffer 120, which buffers the decoded audio in a digital PCM format, as output by the top system 100, and an audio codec unit 130, which converts the digital PCM data to analog PCM data.

In one approach, the audio decoding apparatus maintains the top system 100, audio input buffer 120, and audio codec unit 130 always in the same power management mode, which results in continued power usage from all components when the input buffer 120 and audio codec unit 130 are operating.

In another approach, after the top system 100 has decoded the compressed audio data, transmission of the decoded audio data to the audio input buffer 120 is completed, and a predetermined amount of decoded audio data stored in the audio input buffer 120 has been output by an audio codec unit 130, the top system 100 may be controlled to switch from a current normal mode to a reduced power mode, such as a sleep or standby mode, to reduce overall power consumption of the audio data decoding apparatus. As an example, the CPU of the top system 100 may control the changing of the power mode of the top system 100 from the normal mode to the reduced power mode, e.g., from a full power mode to a power off mode.

Alternatively, the top system 100 transmits the resulting decoded audio data as digital PCM data to the audio input buffer 120 for a predetermined amount of time before the top system 100 is permitted to switch itself to the reduced power mode.

Here, while the top system 100 is within the reduced power mode, the audio codec unit 130 may receive the digital PCM data from the audio input buffer 120, convert the digital PCM data to analog PCM data, and output the converted analog PCM data.

After the audio codec unit 130 has converted a predetermined amount of digital PCM data to analog PCM data, the audio codec unit 130 requests the top system 100 to provide additional digital PCM data to the audio input buffer 120, requiring the top system 100 to cause itself to be switched from the reduced power mode to the full power mode, or from the power off mode to a full power mode.

In general, depending on chosen sizes of the audio input buffer when the audio decoding apparatus is manufactured, the greater the size of the audio input buffer 120 the longer the top system 100 may be maintained in the reduced power mode, or power off mode. Accordingly, conventionally, it is necessary to have a relatively large audio input buffer. However, the necessity of having substantially large buffers or memories increases costs, power usage, and overall physical presence within the audio decoding apparatus.

Additionally, since the power mode of the entire top system 100 is changed from the reduced power mode to the full power mode, the entire top system 100 is fully powered even when only the decoding operation of the audio decoder of the apparatus is being performed, and thus the top system 100 may be required to be in the normal mode more often when additional digital PCM data is needed.

### SUMMARY

According to an aspect of one or more embodiments, there may be provided a system for decoding audio data, including a subsystem including at least one input buffer to receive and store compressed audio data and an audio decoding unit to decode the stored compressed audio data, as decoded audio data, and a top system, distinct from the subsystem, to selectively transmit the compressed audio data to the subsystem based upon management of a power management mode of the top system, with the management of the power management mode of the top system being dependent on operation of the subsystem.

The system may further include an audio codec unit to convert pulse code modulation (PCM) data generated by the audio decoding unit, as the decoded audio data, to an audio output signal, and to output the audio output signal. The decoded audio data may be decoded multi-channel audio data.

The system may further include a data state storage unit to store data processing state information of one or more of the top system and the audio decoding unit.

The data processing state information of the top system may correspond to the power management mode of the top system or represents that the top system will soon change the power management mode of the top system, and wherein the operation of the subsystem is based on the data processing state information of the top system. The data processing state information of the top system may be state information representing that the top system has begun or is transmitting the compressed audio data to the at least one input buffer or that the top system has completed transmitting the compressed audio data to the at least one input buffer.

The data processing state information of the top system may be state information representing that the top system has begun or is transmitting the compressed audio data to the at least one input buffer or that the top system has completed transmitting the compressed audio data to the at least one input buffer, and wherein the operation of the subsystem is based on the data processing state information of the top system.

The data processing state information of the audio decoding unit may correspond to a power management mode of the audio decoding unit or represents that the audio decoding unit will soon change the power management mode of the audio decoding unit, and wherein the management of the power management mode of the top system is based on the data processing state information of the audio decoding unit. The data processing state information of the audio decoding unit may be state information representing that the audio decoding unit has begun or is decoding the stored compressed audio data, that the audio decoding unit has completed decoding the stored compressed audio data, that the audio decoding unit has completed an outputting of the decoded audio data to an output buffer for provision of the decoded audio data to an audio codec unit, or that the audio codec unit has converted a predetermined amount of the decoded audio data.

The data processing state information of the audio decoding unit may be state information representing that the audio decoding unit has begun or is decoding the stored compressed audio data, that the audio decoding unit has completed decoding the stored compressed audio data, that the audio decoding unit has completed an outputting of the decoded audio data to an output buffer for provision of the decoded audio data to an audio codec unit, or that the audio codec unit has converted a predetermined amount of the decoded audio data, and wherein the management of the power management mode of the top system is based on the data processing state information of the audio decoding unit.

The data state storage unit may store data processing state information of the at least one input buffer. The data processing state information of the at least one input buffer may correspond to a power management mode of the at least one input buffer or represents that the at least one input buffer will soon change the power management mode of the at least one input buffer, and wherein the management of the power management mode of the top system is based on the data processing state information of the at least one input buffer.

The data processing state information of the at least one input buffer may be state information representing that the at least one input buffer is not available to receive the compressed audio data from the top system or that the at least one input buffer is empty or ready to receive the compressed audio data from the top system.

The data processing state information of the at least one input buffer may be state information representing that the at least one input buffer is not available to receive the compressed audio data from the top system or that the at least one input buffer is empty or ready to receive the compressed audio data from the top system, and wherein the management of the power management mode of the top system is based on the data processing state information of the at least one input buffer.

When the top system completes transmission of the compressed audio data to the at least one input buffer, the top system or the audio decoding unit may store a corresponding indicator of the completion in the data state storage unit, and the power management mode of the top system is switched to a reduced power mode.

When a transmission of the stored compressed audio data to the audio decoding unit from the at least one input buffer is complete, the audio decoding unit or the at least one input buffer may store a corresponding indicator of the completion in the data state storage unit, and the power management mode of the top system is switched to a full power mode.

When a predetermined amount of the PCM data is converted to the audio output signal, the audio decoding unit may store, in the data state storage unit, information regarding whether residual compressed audio data is present in the at least one audio input buffer, and when no residual compressed audio data exists in the at least one audio input buffer, the power management mode of the top system may be switched to a full power mode.

When the predetermined amount of the PCM data is converted to the audio output signal and the power management mode of the top system is switched to the full power mode, the top system may transmit new compressed audio data to the at least one audio input buffer.

The at least one audio output buffer may store the PCM data and provide the stored PCM data to the audio codec unit.

When the at least one audio input buffer includes a first audio input buffer and a second audio input buffer, the subsystem may control second compressed audio data stored in the second audio input buffer to be transferred to the audio decoding unit when the audio decoding unit completes decoding of first compressed audio data stored in the first audio input buffer.

When the second compressed audio data stored in the second audio input buffer is controlled to be transferred to the audio decoding unit, the top system may be controlled to transfer new first compressed audio data to the first audio input buffer.

The system may further include a memory to store the compressed audio data, and a direct memory access (DMA) to transfer the compressed audio data to the at least one audio input buffer through a bus.

The top system may further include a central processing unit (CPU). The system ay include a system on a chip (SOC), including the top system and the subsystem, with the top system including at least one processor and the subsystem being a digital signal processor (DSP).

According to an aspect of one or more embodiments, there may be provided a system for decoding audio data, including a subsystem including at least one input buffer to receive and store compressed audio data and an audio decoding unit to decode the stored compressed audio data, as decoded audio data, and a top system to receive a transmission request of compressed audio data, and to selectively transmit the compressed audio data to the at least one input buffer, wherein at least one power mode of the top system, controlling of the selective transmission of the compressed audio data, is selectively controlled to be in a power off mode while the audio decoding unit decodes the stored compressed audio data.

The top system may be in the power off mode during the decoding of the stored compressed audio data and controlled to not change to a full power mode until the decoding of the stored compressed audio data is complete or the at least one input buffer is empty or indicative of being ready to receive and store additional compressed audio data.

The top system may enter the power off mode immediately after sending an interrupt instruction to the audio decoding unit when transmission of the compressed audio data to the at least one input buffer is complete.

The system may further include a data state storage unit to store data processing state information of one or more of the top system and the audio decoding unit.

When the top system completes transmission of the compressed audio data to the at least one input buffer, the top system or the audio decoding unit may store a corresponding indicator of the completion in the data state storage unit, and the controlling of the at least one power mode of the top system may control the at least one power mode to be switched to the power off mode.

When a transmission of the stored compressed audio data to the audio decoding unit from the at least one input buffer is complete, the audio decoding unit or the at least one input buffer may store a corresponding indicator of the completion in the data state storage unit, and the controlling of the at least one power mode of the top system may control the at least one power mode to be switched to a full power mode.

The he audio decoding unit may decode the compressed audio data to pulse code modulation (PCM) data and the system may further include an audio codec unit to convert the PCM data to an audio output signal, and to output the audio output signal.

When a predetermined amount of the PCM data is converted to the audio output signal, the audio decoding unit may store, in the data state storage unit, information regarding whether residual compressed audio data is present in the at least one audio input buffer, and when no residual compressed audio data exists in the at least one audio input buffer, the controlling of the at least one power mode of the top system may control the at least one power mode to be switched to a full power mode.

When the predetermined amount of the PCM data is converted to the audio output signal and the at least one power mode of the top system is controlled to be switched to the full power mode, the top system may transmit new compressed audio data to the at least one audio input buffer.

When the at least one input buffer includes a first input buffer and a second input buffer, the at least one power mode of the top system may be controlled to be at a full power mode while transferring new compressed audio data to the second input buffer and while the audio decoding unit is decoding stored compressed audio data from the first input buffer, such that the at least one power mode of the top system is switched to the power off mode upon completion of the transferring of the new compressed audio data to the second input buffer while the audio decoding unit is decoding either of the stored compressed audio data from the first input buffer or the new compressed audio data stored in the second input buffer.

The system may be a system on a chip (SOC), including the top system and the subsystem, with the top system including at least one processor and the subsystem being a digital signal processor (DSP).

The at least one power mode of the top system may be selectively controlled to be one of plural available power management modes, including a sleep mode where the top system is in a ‘power off’ state, a deep idle and deep stop mode where the top system is in a ‘power off with L2 retention’ state, an idle and stop mode where the top system is maintained in a ‘standby’ state, and a normal mode where the top system is in a ‘run’ or ‘full power’ state, and wherein the at least one power mode of the top system may be selectively controlled be in one of the deep idle and deep stop mode in the power off mode and in the normal mode in a full power mode.

According to an aspect of one or more embodiments, there may be provided a system for decoding audio data, a subsystem including at least one input buffer to receive and store compressed audio data from a top system, distinct from the subsystem, and an audio decoding unit to decode the stored compressed audio data, as decoded audio data, wherein the subsystem controls the top system to selectively transmit the compressed audio data to the at least one input buffer and controls at least one power mode of the top system, controlling of the selective transmission of the compressed audio data, to be in a power off mode while the audio decoding unit decodes the stored compressed audio data.

The subsystem may control the top system to be in the power off mode during the decoding of the stored compressed audio data and control the top system to not change to a full power mode until the decoding of the stored compressed audio data is complete or the at least one input buffer is empty or indicative of being ready to receive and store additional compressed audio data. The subsystem may control the top system to enter the power off mode when transmission of the compressed audio data by the top system to the at least one input buffer is complete.

According to an aspect of one or more embodiments, there may be provided a method of decoding audio data, including receiving compressed audio data from a separately provided top system, and storing the compressed audio data in at least one audio input buffer, decoding the stored compressed audio data of the at least one audio input buffer using an audio decoding unit separate from the top system, as decoded audio data, and managing a power management mode of the top system to selectively transmit the compressed audio data, with the management of the power management mode of the top system being dependent on the storing of the compressed audio data and the decoding of the stored compressed audio data.

According to an aspect of one or more embodiments, there may be provided a method for decoding audio data, including receiving compressed audio data from a separately provided top system, and storing the compressed audio data in at least one audio input buffer, decoding the stored compressed audio data of the at least one audio input buffer using an audio decoding unit separate from the top system, as decoded audio data, and controlling at least one power mode of the top system, controlling of a selective transmission of the compressed audio data to the at least one audio input buffer, to be in a power off mode while the audio decoding unit is decoding the stored compressed audio data.

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a conventional audio data decoding apparatus;

FIG. 2 illustrates an audio data decoding system, according to one or more embodiments;

FIG. 3 illustrates an audio data decoding method, according to one or more embodiments;

FIG. 4 illustrates an audio data processing method, according to one or more embodiments;

FIG. 5 illustrates an audio data decoding system, according to one or more embodiments;

FIG. 6 illustrates a subsystem, such as the subsystem 220 of FIG. 2, according to one or more embodiments;

FIG. 7 illustrates power management modes for a top system and/or components of a subsystem, according to one or more embodiments;

FIG. 8 graphically illustrates a difference in power usage between one or more embodiments and a conventional approach;

FIG. 9 illustrates an audio data reproducing device, according to one or more embodiments;

FIG. 10 illustrates a network system, according to one or more embodiments; and

FIG. 11 illustrates a mobile audio data reproducing device, such as the audio data reproducing device of FIG. 9, according to one or more embodiments.

### DETAILED DESCRIPTION

Additional aspects and/or advantages of one or more embodiments will be set forth in part in the description which follows and, in part, will be apparent from the description, or may be learned by practice of one or more embodiments of disclosure. One or more embodiments are inclusive of such additional aspects.

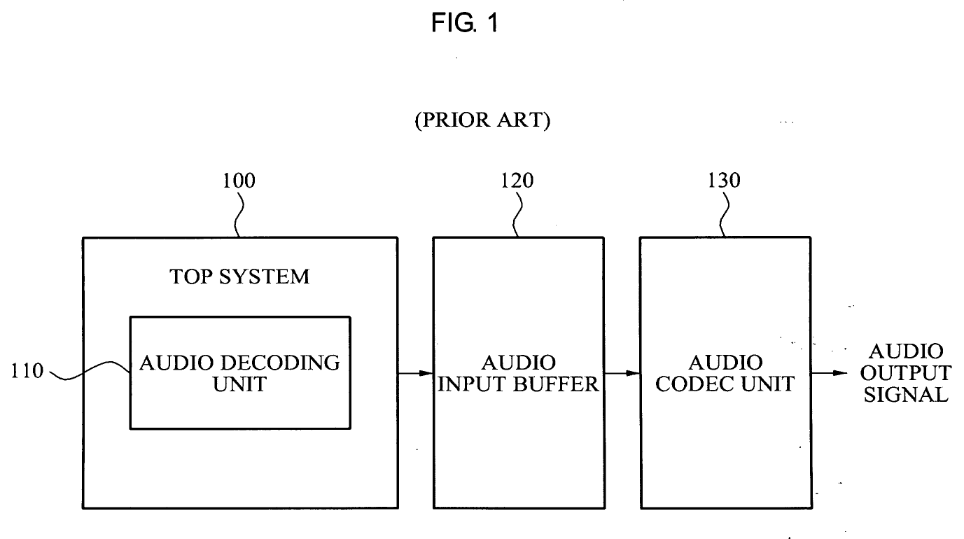

With the above conventional approaches, the necessity of having substantially large buffers or memories increases costs, power usage, and overall physical presence within an audio decoding system. The inventors of the present application have discerned that there are additional inefficiencies caused by collectively controlling the audio decoder and the remainder of the top system 100 of FIG. 1. For example, from a point of view of a one-second stereo audio signal sampled to 48 kHz, a corresponding decoded and output digital PCM data for that same second requires 187.5 kbytes of storage or buffering space, while it was observed by the present inventors that compressed audio data, such as in the MP3 format, sampled at 128 kbps only requires 15.625 kbytes. Seen another way, the audio input buffer 120 is required to be at least 12 times larger than a memory within the top system 100 providing the compressed audio data to the decoder of the top system 100.

Accordingly, the inventors of the present application have discerned that the conventional top system configuration is undesirable for both power management and required storage requirements. In one or more embodiments, power management can be improved and storage requirements reduced by separating the power management approaches for the decoder, and corresponding input buffer prior to the decoder, from the remainder of the top system or one or more processors of the top system.

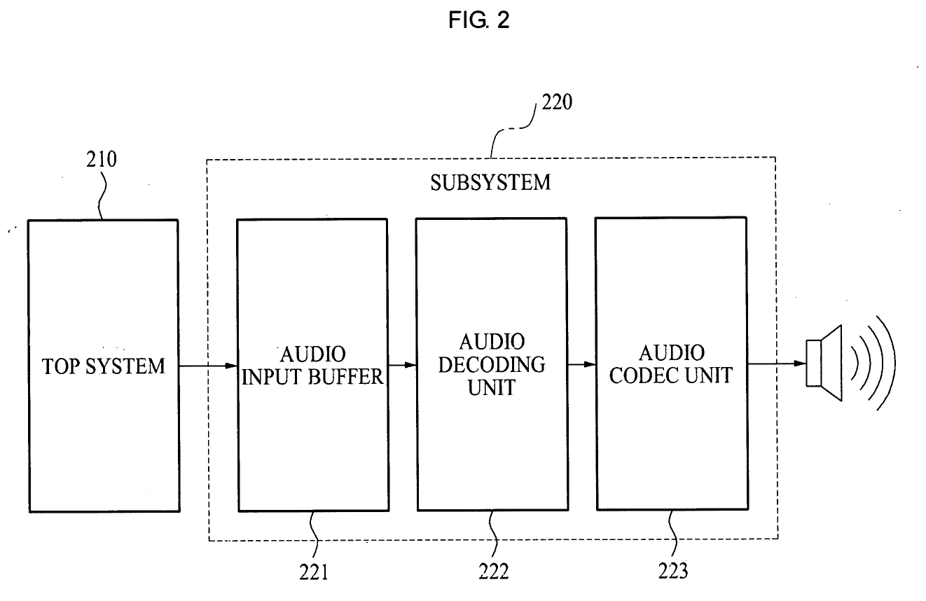

FIG. 2 illustrates an audio data decoding system, according to one or more embodiments.

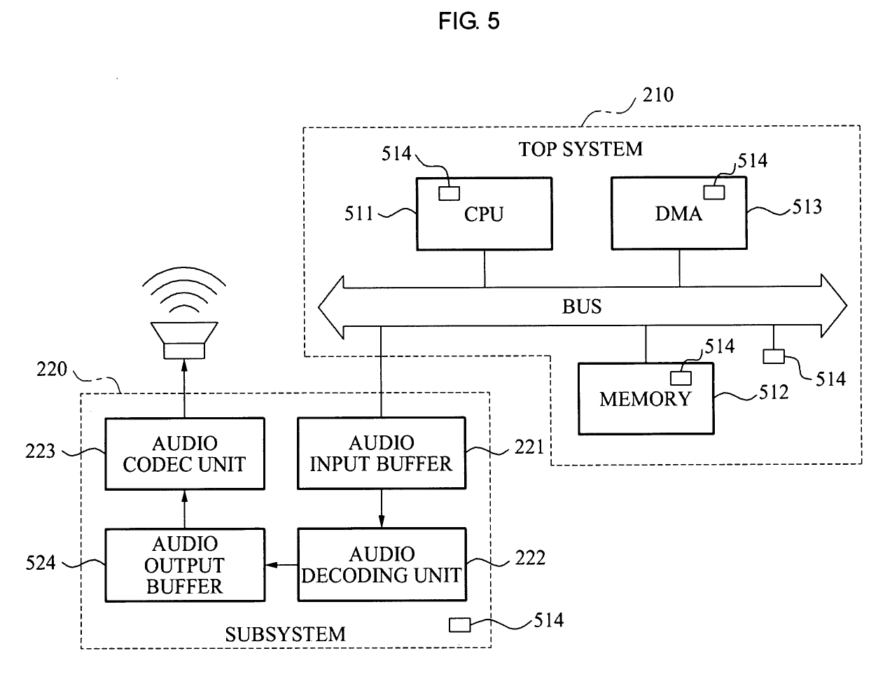

The audio data decoding system of FIG. 2 may include a top system 210, an audio input buffer 221, an audio decoding unit 222, and an audio codec unit 223. The audio input buffer 221, audio decoding unit 222, and audio codec unit 223 may be configured as a subsystem 220, separate from the top system-210. In one or more embodiments, the subsystem may be a digital signal processor (DSP) distinguished from the top system, e.g., a central processing unit (CPU) of the top system 210, such as CPU 511 of FIG. 5. Additionally, in one or more embodiments, the top system 210 and subsystem 220 may be different processing elements of a single device, such as a system on a chip (SOC), or application specific circuit (ASIC), for example. In an embodiment, the top system 210 and subsystem 220 may also be physically separate from each other, such as when a CPU, part of the top system 210, is configured to be on an electronic board and connected to the subsystem 220 through wiring or conductive paths, for example.

The top system 210 may receive a conversion request of compressed audio data, such as a request to reproduce audio, and accordingly transmit the compressed audio data to the subsystem 220. In one or more embodiments, the subsystem 220 is separately controlled from the top system 210 and may convert the compressed audio data to an audio output signal, and output the converted audio output signal. For example, the compressed audio may be of any format, such as MP3, AAC, or WMA, noting that in one or more embodiments uncompressed audio data may also be transmitted from the top system 210 to the subsystem 220. The separate controlling of the top system 210 and the subsystem 220 includes separately controlling power management modes, states, or levels of the top system 210, or at least one or more processors of the top system 210, from power management modes of the subsystem 220, or at least the audio decoding unit 222 of the subsystem 220. Herein, usage of the terms ‘mode’, ‘state’, or ‘level’ with regard to power management have generally the same meaning, consistent with their well known usage, e.g., a state of the top system 210 may be that the top system 210 is in a particular power management mode, state, or level. The top system 210 is also not required to be a processor and/or memory, physically connected to the subsystem 220 but could be a separate device, which is controlled to operate with the subsystem 220, such as a separate device that selectively provides compressed audio to the subsystem 220 through an IR signal or other transmission which would not require interaction with a processor or CPU and/or a memory, which may be physically connected to the subsystem 220.

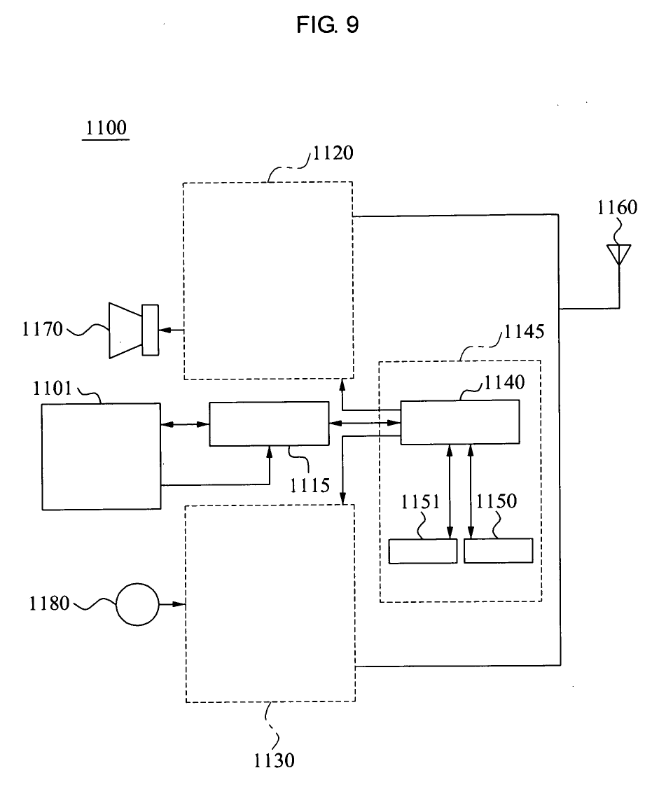

The subsystem 220 may include at least one audio input buffer 221 to receive and store the compressed audio data, the audio decoding unit 222 to restore the compressed audio data to digital pulse code modulation (PCM) data, and an audio codec unit 223 to convert the digital PCM data to analog PCM data or some other audio output signal, and to output the converted audio output signal. In one or more embodiments, the subsystem 220 may not include the audio codec unit 223, or the audio codec unit 223 and any buffer between the audio decoding unit 222 and the audio codec unit 223. The audio codec unit 223 may be a digital to analog converter (DAC). An output audio signal may be provided to one or more speakers, such as speaker(s) 1170 of FIG. 9. The illustrated speaker 1170 of FIG. 9 may represent multiple speakers for differing channels, such as for respectively receiving decoded channel signals from a multi-channel signal decoded by the audio decoding unit 222.

While the subsystem 220 performs decoding of the compressed audio data, it may not be necessary for one or more components of the top system 210 to be maintained in a normal or even partially reduced power management mode. One or more components of the top system 210 may be caused to substantially reduce power consumption, e.g., by entering a deep idle and deep stop level, as only an example. Accordingly, in one or more embodiments, because the decoding operation is not performed in the top system 210, which conventionally was a reason for large audio data processing power consumption, a substantial reduction in power consumption can be obtained by separately controlling the power management modes between the top system 210 and subsystem 220. Accordingly, compared to the limited period of time the top system 100 of FIG. 1 was able to be maintained in a reduced power mode, in one or more embodiments the period of time for maintaining a top system 210 in the reduced power mode may be substantially increased, reducing total power consumption.

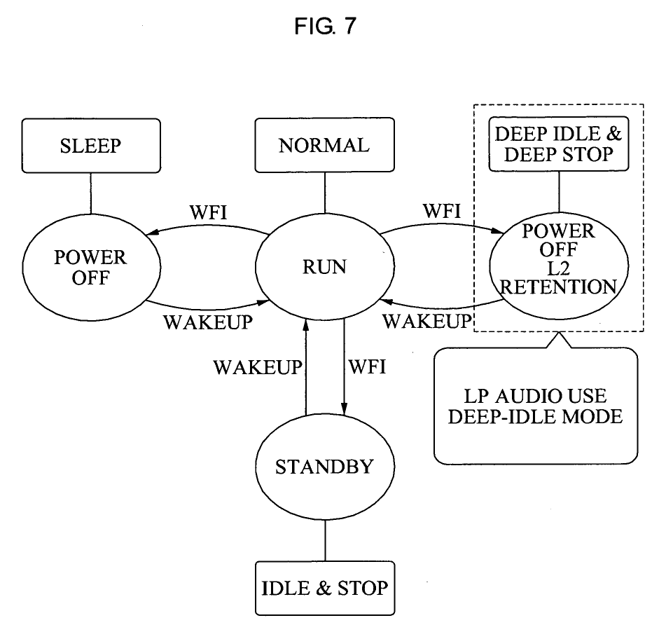

According to one or more embodiments, FIG. 7 illustrates different available power management modes for the top system 210, noting that similar power management modes are equally available for one or more components of the subsystem 220. FIG. 7 illustrates a sleep mode, normal mode, deep idle and deep stop mode, and idle and stop mode. As reduced power modes, in the sleep mode, the top system 210 may be powered off and considered in a ‘power off’ mode or state, while in the deep idle and deep stop mode the top system 210 is powered off with L2 cache retention, and considered in a corresponding ‘power off with L2 retention’ mode or state. In the idle and stop mode, the top system 210 is maintained in a ‘standby’ mode or state. In the normal mode there may be no or limited power management and the top system would be considered to be in a ‘run’ or ‘full power’ mode or state. One or more embodiments may operate one or more components of the subsystem 220, and at least the audio decoding unit 222, while the top system 210, and at least one or more processors of the top system 210 which would normally provide the compressed audio data to the subsystem 220, are in the deep idle and deep stop mode. Alternatively, the entire top system 210, including all processors of the top system 210, may be maintained in the deep idle and deep stop mode while the subsystem 220, or at least the audio decoding unit 222, is maintained in the normal power management mode. In an embodiment, the top system 210 is controlled to change from a reduced power mode to a higher power mode, e.g., with greater power usage potential, through a wakeup or ‘interrupt’ instruction, and is controlled to change from the higher power mode to the reduced mode, e.g., with less power usage capabilities, through a wait for interrupt (WFI) instruction.

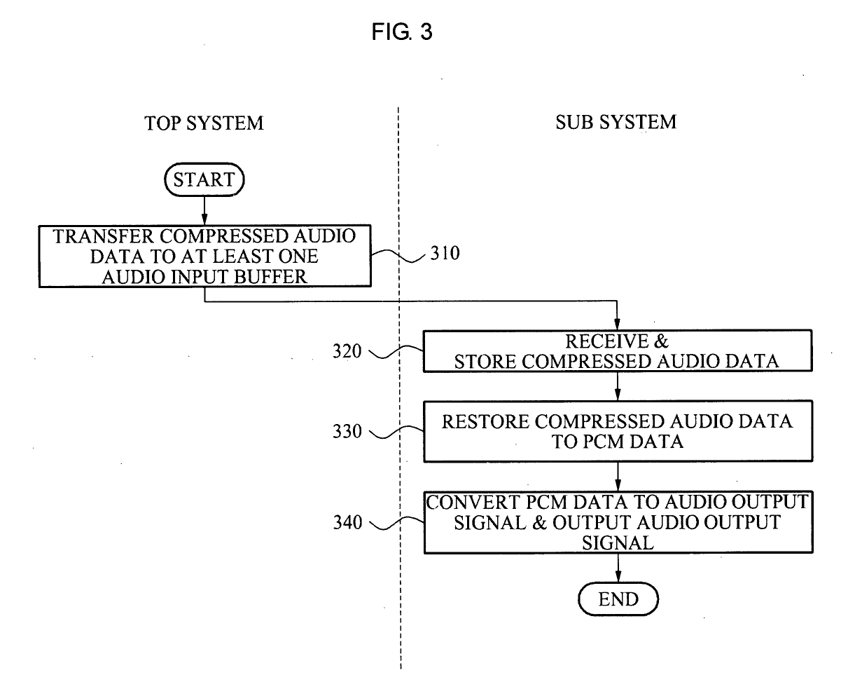

FIG. 3 illustrates an audio data decoding method, according to one or more embodiments.

Accordingly to one or more embodiments, it is possible to greatly reduce the power consumption caused by top system and/or an audio decoding unit through operations illustrated in FIG. 3, for example.

The top system 210 may receive a conversion request of compressed audio data, and in response, transmit the compressed audio data to at least one audio input buffer 221 of the subsystem 220, in operation 310.

In one or more embodiments, the audio data decoding system may include a data state storage unit to store data processing state information of the top system 210 and/or the subsystem 220, or the audio decoding unit 222 of the subsystem 220, for example. In one or more embodiments, the top system 210 and/or the subsystem 220, or one or more components of each the top system 210 and subsystem 220, include a corresponding data state storage unit. The audio data decoding system may also include the data state storage unit separate from either of the top system 210 or the subsystem 220. Using FIG. 7 as an example, information of the power management mode or state of the top system 210 may be stored in a corresponding data state storage unit, or a single data state storage unit, and a request for a power management mode or state change may be transmitted to the same data state storage unit, e.g., as state information. There may be one or more data state storage units. However, for explanatory purposes, FIG. 5 illustrates an example data state storage unit 514, and further reference below to data state storage unit 514 will be a reference to a single one of the illustrated potential data state storage units 514 of FIG. 5.

In one or more embodiments, when any of operation 310 of the top system 210 or operations 320 through 340 of the subsystem 220 are initiated, being performed, or complete, the top system 210 and/or the subsystem 220, or audio decoding unit 222, may store indicators or state information regarding the initiation, current processing, or completion of respective operations 310 through 340 in the data state storage unit 514.

In operation 320, the at least one audio input buffer 221 of the subsystem 220 may receive and store the compressed audio data.

In an operation, when transmission of the compressed audio data by the top system 210 to the audio input buffer 221 is complete, the top system 210 may store an indicator of the completion of operation 310 in the data state storage unit 514, and the top system 210, or one or more processor configured to provide the subsystem 220 compressed audio data, is caused to change respective power management modes or states to a reduced power mode. In one or more embodiments, the reduced power mode or state is the power off with L2 retention mode, such as shown in FIG. 7, differentiated from the sleep or standby power management modes or states. Accordingly, it is possible to significantly decrease total power consumption. Completion of the transmission of the compressed audio data may be based upon a predetermined amount of compressed audio data being transferred to the audio input buffer 221 or a predetermined period of time having expired since transfer of the compressed audio data to the audio input buffer 221 began. The completion could equally be based on some indication by the input buffer 221 to the top system 210, e.g., when the input buffer 221 is or may shortly become full, noting that alternative reasons for considering a current transmission of the compressed audio data from the top system 210 to the input buffer 221 as being complete are equally available.

In operation 330, the audio decoding unit 222 may receive the compressed audio data from the at least one audio input buffer 221 and begin restoring the compressed audio data to digital PCM data, as only an example, noting that the audio decoding unit 222 is not limited to generating digital PCM data, as alternate embodiments are equally available.

In operation 340, the audio codec unit 223 may convert the digital PCM data to analog PCM data or any other audio output signal, for example, any analog signal, digital signal and the like, and then output the converted audio output signal. In an embodiment, the illustrated speaker(s) 1170 of FIG. 9 also represent an amplifier stage, which may amplify the converted audio output signal and drive one or more of the speakers 1170 so the amplified audio can be audibly heard. In an embodiment, the audio codec unit 223 is controlled by the audio decoding unit 222 to start the conversion of the digital PCM data to the analog PCM data or other audio signal when all of the digital PCM data for each frame is respectively output to one or more audio output buffers 524, for example.

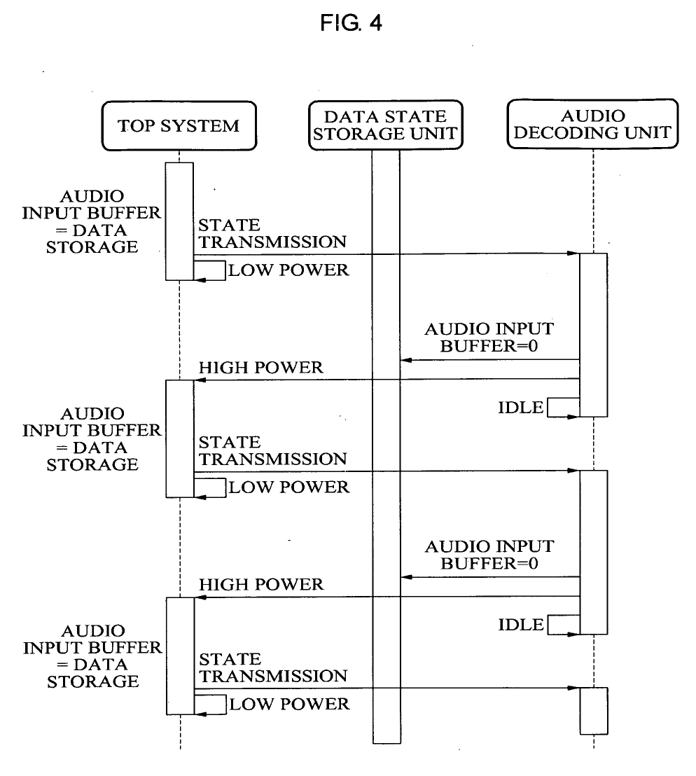

FIG. 4 illustrates an audio data processing method, according to one or more embodiments.

As illustrated in FIG. 4, in an embodiment when a top system 210 completes transmission of compressed audio data to an audio input buffer 221 of the subsystem 220, the top system 210 stores a ‘state transmission’ indicator in the data storage unit 514, and accordingly changes its power management mode to the reduced power mode. The audio decoding unit may observe this change in power management mode or state, or observe a change in state of the audio input buffer 221, and begin decoding operations. In an embodiment, the top system 210 transmits an interrupt instruction to the audio decoding unit 222, and then change to the reduced power mode. When the audio input buffer 221 is empty, e.g., audio input buffer=0, or ready for additional compressed audio data, the audio input buffer 221 or the audio decoding unit 222 stores an indicator in the data storage unit 514 that the audio input buffer 221 needs additional compressed audio data. The top system 210 then transitions from the reduced power mode to the full power mode, and transmits additional compressed audio data to the audio input buffer 221, and then transitions back to the reduced power mode. This process is repeated until all corresponding compressed audio data has been transferred to the audio input buffer 221.

Accordingly, in one or more embodiments, when the top system 210 or the subsystem 220, or the audio decoding unit 222, as only examples, initiates and/or completes an operation of reading, writing, or processing compressed audio data, the aforementioned data state storage unit 514 may be controlled to store an indicator of the initiation and/or completion of the respective operations.

By referring to the initiation and/or completion indicators in the data state storage unit 514, the top system 210 and/or one or more components of the subsystem 220, including the audio decoding unit 222, may determine which operation to currently perform, e.g., whether to read, write, or process the compressed audio data, and may perform the corresponding operation.

By applying such a data communication scheme, using the data state storage unit 514, the audio input buffer 221 may store, in the data state storage unit 514, an indication of the state that the input buffer 221 as being empty and then an interrupt instruction may be sent to the top system 210 so that the top system 210 may be controlled to be switched from reduced power mode to a full power mode. In an embodiment, the interrupt instruction may be sent from the data state storage unit 514. Alternatively, the interrupt instruction may be sent from the audio decoding unit 222, based on the audio input buffer 221 or the audio decoding unit 222 storing the empty indicator in the data state storage unit 514. The interrupt may be sent from the audio input buffer 221

The top system 210 switched to the full power mode may read one or more indicators from the data state storage unit 514 to determine whether the audio input buffer 221 is empty or an indicator in the data state storage unit 514 stating that the audio input buffer 221 is ready for more compressed audio data. The top system 210 may also determine from the data state storage unit 514 whether there were any errors and/or early termination occurrences in any of the operations of the components of the subsystem 220, e.g., in operations 320 through 340 of FIG. 3, and may operate a corresponding operation. The data state storage unit 514 may store additional and/or alternative indicators that may be relevant to the operation of the top system 210. The storing of one or more of the indicators in the data state storage unit 514 may act as the above noted interrupt instructions.

FIG. 5 illustrates an audio data decoding system, according to one or more embodiments.

Referring to FIG. 5, a top system 210 may include a memory 512 to store compressed audio data, and a direct memory access (DMA) 513 to transfer the compressed audio data to at least one audio input buffer 221, e.g., via a bus. A subsystem 220 may include the at least one audio input buffer 221, an audio decoding unit 222, an audio codec unit 223, and at least one audio output buffer 524. As noted above, in an embodiment, the audio codec unit 223 or both the audio codec unit 223 and the audio output buffer 524 may be separate from the subsystem 220.

When a user issues a play command, the top system 210 may be controlled to transfer compressed audio data from one or more other memories, e.g., a memory having a NAND format, to the memory 512 through the DMA 513. The DMA 513 may then be controlled by the CPU 511 to access the memory 512 and transfer the compressed audio data to the audio input buffer 221.

For example, a CPU 511 may verify a compression format by analyzing the compressed audio data, and may then transfer, to the audio decoding unit 222, the compressed audio data and an audio decoder instruction suitable for the verified compression format.

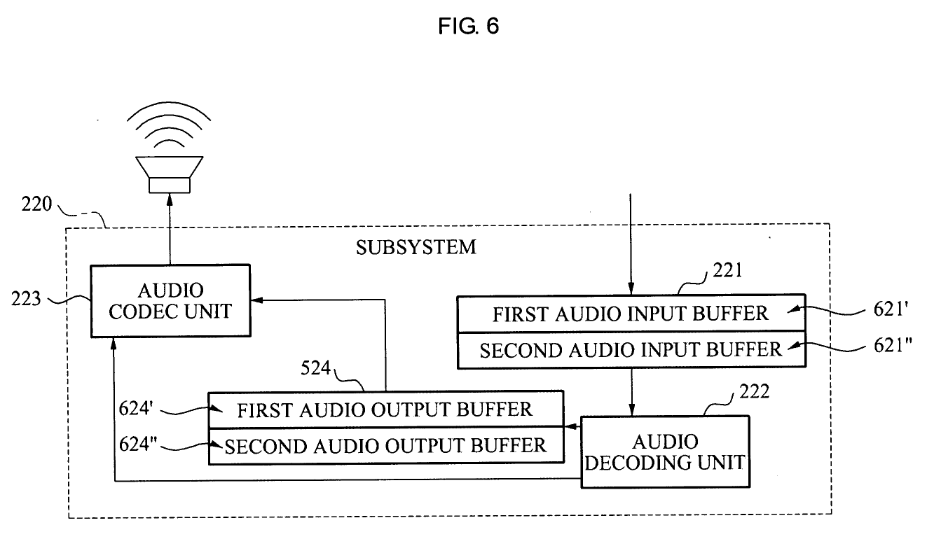

FIG. 6 illustrates a subsystem, such as the subsystem 220 of FIG. 2, according to one or more embodiments.

Referring to FIG. 6, there may be one or more audio input buffers 221 and audio output buffers 524.

For example, according to one or more embodiments, two audio input buffers may operate as a pair and perform a double buffering scheme for alternatively decoding audio data.

When all of the compressed audio data stored in a first audio input buffer 621′ among the one or more audio input buffers 221 is transferred to the audio decoding unit 222 and is restored to PCM data, for example, the one or more audio input buffers 221 may transfer, to the audio decoding unit 222, the compressed audio data stored in a second audio input buffer 621″ among the one or more audio input buffers 221.

For example, the CPU 511 of FIG. 5 may control the transfer of a portion of the compressed audio data from the memory 512 to the first audio input buffer 621′ and the second audio input buffer 621″ by controlling the DMA 513. In an embodiment, the CPU 511 controls the DMA 513 to transmit a predetermined amount of compressed audio data to each of the first audio input buffer 621′ and the second audio input buffer 621″. In such an embodiment, the predetermined amount may be 18 kbytes, such that the DMA 513 transfers 18 kbytes of compressed audio data from the memory 512, which may be DRAM memory, or any alternative memory. In one or more embodiments, the first audio input buffer 621′ and the second audio input buffer 621″ have the same capacity, such as 18 kbytes, such that the CPU 511 may transfer 36 kbytes of compressed audio data to the first audio input buffer 621′ and the second audio input buffer 621″ through the DMA 513 in a full power mode. In an embodiment, the first audio input buffer 621′ and the second audio input buffer 621″ have different capacities. The DMA 513 may provide the compressed audio data from an additional memory, such as a NAND based memory, noting again that alternative embodiments are equally available.

The CPU 511 may further control or send an appropriate instruction for the audio decoding unit 222 to operate, and may be switched to a deep idle mode, as a reduced power mode shown in FIG. 7. Alternatively, the audio decoding unit 222 may operate independently of the CPU 511, based upon the power management mode of the CPU 511, or one or more first audio input buffers 221, e.g., as indicated in the data state storage unit 514.

Referring again to FIG. 3, in operation 330, in an embodiment the audio decoding unit 222 may receive the compressed audio data from the one or more audio input buffers 221 and restore the compressed audio data to digital PCM data.

For example, in an embodiment, to restore a first frame of audio data, the audio decoding unit 222 may read and restore the compressed audio data from the first audio input buffer 621′ and then output the restored digital PCM data to a first audio output buffer 624′.

To restore a second frame of the audio data, the audio decoding unit 222 may read and restore the compressed audio data from the second audio input buffer 621″ and output the PCM data to a second audio output buffer 624″.

Referring again to FIG. 3, in operation 340, the audio codec unit 223 may convert the digital PCM data to analog PCM data or any audio output signal, for example, an analog signal, a digital signal and the like, and then output the converted audio output signal.

For example, when the decoded audio data corresponding to any single frame is completely output as digital PCM data to either of the first audio output buffer 624′ and the second audio output buffer 624″, the audio decoding unit 222 may send an instruction to the audio codec unit 223 so that the analog PCM data may be output.

When a predetermined amount of the digital PCM data has been converted by the audio codec unit 223 to the analog PCM data or audio output signal, the audio decoding unit 222 may store, in the data state storage unit 514, information regarding whether residual compressed audio data is present in either one of the audio input buffers 221.

When there is no residual compressed audio data in either, or both, of the one or more audio input buffers 221, the top system 210 may be switched to a full power mode to transfer additional compressed audio data to the one or more audio input buffers 221.

In an embodiment, when the above process is performed in a first frame, and when all of the compressed audio data stored the first audio input buffer 621′ is restored, the audio decoding unit 222 may request the CPU 511 for compressed audio data, and start restoring the compressed audio data stored in the second audio input buffer 621″, for a second frame.

In this case, the top system 210 may be switched from the reduced power mode to full power mode to transfer a predetermined amount of compressed audio data from the memory 512 to the first audio input buffer 621′ via the DMA 513. Next, the top system 210 may be switched again from the full power mode to the reduced power mode to reduce power consumption.

When all of the compressed audio data stored in the second audio input buffer 621″ has been restored, the audio decoding unit 222 may again request the top system 210 for additional compressed audio data for the second audio input buffer 621″ and start restoring the compressed audio data stored in the first audio input buffer 621′.

The top system 210 may be switched from the reduced power mode to the full power mode to transfer a predetermined amount of compressed audio data from the memory 512 to the second audio input buffer 621″ via the DMA 513, and may then be switched again to the reduced power mode, reducing power consumption.

As described above, according to one or more embodiments, an audio data decoding system and method may separate power management control between an audio decoding unit and a top system that provides the audio decoding unit compressed audio data, e.g., provides the audio decoding unit compressed audio data in frame units, and provide the audio decoding unit in a subsystem. Accordingly, even though decoding of audio data is performed for a relatively long period of time, the top system may be maintained in a reduced power mode or state. Accordingly, it is possible to significantly decrease total power consumption.

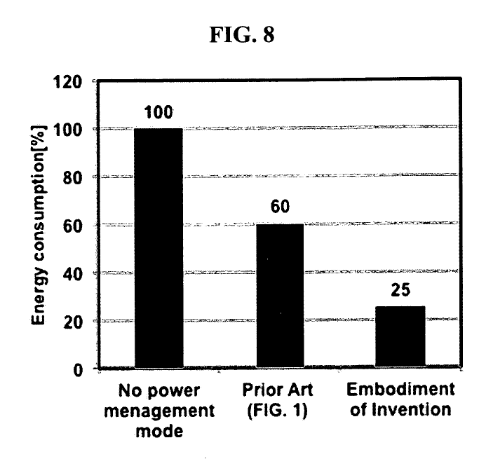

For example, FIG. 8 illustrates the proposed power mode switching based on input pre-buffer (PMS-IPB) of an embodiment of the present application, with 25% energy consumption, compared to a conventional dynamic voltage frequency scheme (DVFS) approach, identified as having no power management mode, with 100% energy consumption, and the prior art system of FIG. 1, which represents a power mode switching based on output pre-buffer (PMS-OPB), with 60% energy consumption. Accordingly, with the illustrated embodiment results of FIG. 8, there is a substantial decrease in power consumption, with a four-fold decrease over a DVFS approach and two-fold decrease over a PMS-OPB approach.

According to one or more embodiments, an audio data decoding system and method may transfer audio data to an audio input buffer of a subsystem in a compressed state. Accordingly, it is possible to significantly decrease the capacity of the audio input buffer.

According to one or more embodiments, since audio data is transferred in a compressed state to an input buffer for storing the audio data, it is possible to additionally decrease a memory request amount of a buffer.

FIGS. 9 through 11 illustrate an audio reproducing device, system, and method, according to one or more embodiments.

Referring to FIG. 9, the audio reproducing device 1100 includes a display and user interface 1101, a video controller 1115, a multimedia decoder 1120, a multimedia encoder 1130, and a top system 1145, transmitter/receiver 1160, speaker 1170, and microphone/camera 1180, for example. The top system 1145 may include a central processing unit (CPU) 1140, a memory 1150, and a direct memory access (DMA) 1151. The multimedia decoder 1120, multimedia encoder 1130, controller 1115, CPU 1140, memory 1150, and DMA 1151 may all communicate through a common bus, as only an example. The display and user interface 1101 may be a single device, such as a touch screen, and/or the display and one or more user interfaces may be separate devices. The encoder 1130 may encode captured image data and/or captured audio data, e.g., captured through the microphone/camera 1180, according to any conventional video/audio encoding schemes, such as any MPEG standard, as only an example. The microphone/camera 1180 may be single device or separate devices. The decoder 1120 may decode captured image data and/or captured audio data, or reproduce image data or audio data stored in the memory 1150, for example, according to any of the above discussed approaches, e.g., with separate power management between the decoder 1120 and the CPU 1140, or the entire top system 1145, as discussed above.

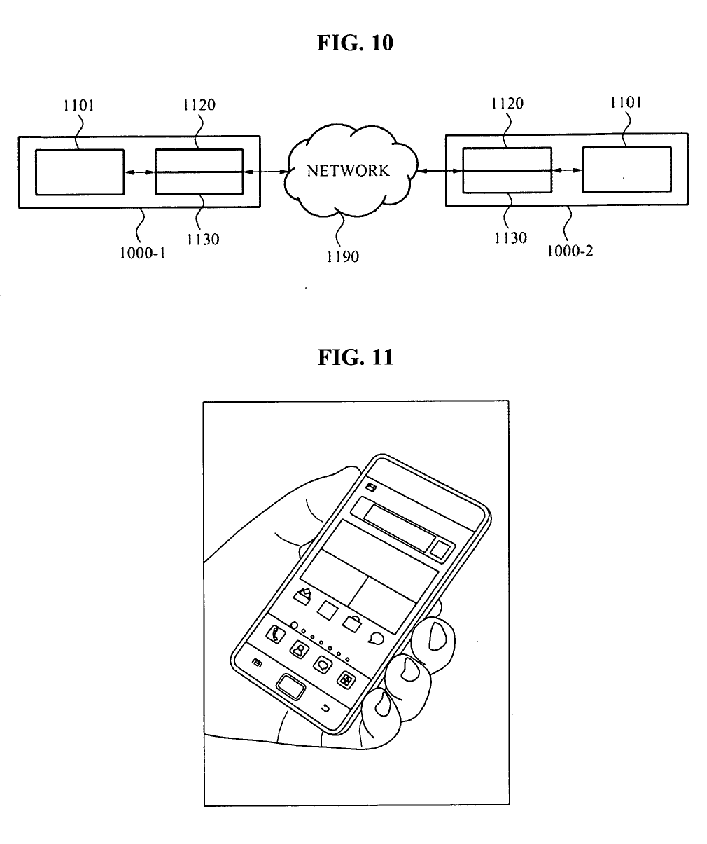

The transmitter/receiver 1160 may transmit encoded data to the remote audio reproducing device, such as the second audio reproducing device 1000-2 of FIG. 10. The transmitter/receiver 1160 may also receive similarly encoded information from the remote audio reproducing device and forward the same to the decoder 1120. The decoded video/audio information is then output through the display and/or speaker 1170. The decoder 1120 may include the audio input buffer 221, audio decoding unit 222, and audio codec unit 223, configured as the subsystem 220, of FIG. 2. The decoder 1120 may be a digital signal processor (DSP), which may also include encoder 1130. In one or more embodiments, the audio reproducing device 1100 is a system of chip (SOC) device, including such an DSP and at least the CPU 1140, according to any of the above discussed approaches, e.g., with separate power management between the DSP and the CPU 1140, or the entire top system 1145, as discussed above.

Referring to FIG. 10, the system includes an audio reproducing device 1100 and a remote audio reproducing device of FIG. 9, as the first audio reproducing device 1000-1 and second audio reproducing device 1000-2, in one or more embodiments, each being an audio reproducing device corresponding to the audio reproducing device 1100 of FIG. 9. The network 1190 may be any communication path available between the first audio reproducing device 1000-1 and the second audio reproducing device 1000-2, such as an Internet Protocol based network or wireless protocol, or a combination of the same. Both first and second audio reproducing devices 1000-1 and 1000-2 do not need to be an audio reproducing device corresponding to the audio reproducing device 1100 of FIG. 9. As only an example, the second audio reproducing device 1000-2 may alternatively be an encoded audio and/or image/video data providing server or a computing device that is configured to transfer encoded audio and/or image/video data to the first audio reproducing device 1000-1. Accordingly, the network 1190 may be any communication path between the two or more devices, including a serial data channel, such as a USB or similar adapter or connector. The encoded audio and/or image/video data may be streamed audio and/or video data or provided from a respective local storage device.

Referring to FIG. 11, an alternative view of the audio reproducing device 1100 of FIG. 9 is shown. Though illustrated in FIG. 11 as a mobile phone or smart phone, the audio reproducing devices 1100 of FIGS. 9 and 10 may not include phone capabilities and/or video playback capabilities, e.g., with only a user interface and no display. The first or second audio reproducing devices 1000-1 and 1000-2 in the system 1110, may be any same or different type of audio reproducing device in the system 1110, including music playback only devices, tablet computer devices, mobile phones, PDAs, smart phones, a personal computer, teleconferencing devices, set-top boxes, television, etc.

In one or more embodiments, any apparatus, system, and unit descriptions herein include one or more hardware devices and/or hardware processing elements/devices. Additionally, one or more embodiments may include a configuration similar to that of FIG. 9, including one or more processing elements in the controller, CPU, display, encoder, and/or decoder hardware portions of the mobile device. Accordingly, in one or more embodiments, any described apparatus, system, and unit may further include one or more desirable memories, and any desired hardware input/output transmission devices, as only examples. Further, the term apparatus should be considered synonymous with elements of a physical system, not limited to a device, i.e., a single device at a single location, or enclosure, or limited to all described elements being embodied in single respective element/device or enclosures in all embodiments, but rather, depending on embodiment, is open to being embodied together or separately in differing devices or enclosures and/or differing locations through differing hardware elements.

In addition to the above described embodiments, embodiments can also be implemented through computer readable code/instructions in/on a non-transitory medium, e.g., a computer readable medium, to control at least one processing element/device, such as a processor, computing device, computer, or computer system with peripherals, to implement any above described embodiment or aspect of any embodiment. The medium can correspond to any defined, measurable, and tangible structure permitting the storing and/or transmission of the computer readable code. Additionally, one or more embodiments include the at least one processing element or device.

The media may also include, e.g., in combination with the computer readable code, data files, data structures, and the like. One or more embodiments of computer-readable media include magnetic media such as hard disks, floppy disks, and magnetic tape; optical media such as CD ROM disks and DVDs; magneto-optical media such as optical disks; and hardware devices that are specially configured to store and/or perform program instructions, such as read-only memory (ROM), random access memory (RAM), flash memory, and the at least one processing device, respectively. Computer readable code may include both machine code, such as produced by a compiler, and files containing higher level code that may be executed by the computer using an interpreter, for example. The media may also be any defined, measurable, and tangible elements of one or more distributed networks, so that the computer readable code is stored and/or executed in a distributed fashion. In one or more embodiments, such distributed networks do not require the computer readable code to be stored at a same location, e.g., the computer readable code or portions of the same may be stored remotely, either stored remotely at a single location, potentially on a single medium, or stored in a distributed manner, such as in a cloud based manner. Still further, as noted and only as an example, the processing element could include a processor or a computer processor, and processing elements may be distributed and/or included in a single device. There may be more than one processing element and/or processing elements with plural distinct processing elements, e.g., a processor with plural cores, in which case one or more embodiments would include hardware and/or coding to enable single or plural core synchronous or asynchronous operation.

The computer-readable media may also be embodied in at least one application specific integrated circuit (ASIC) or Field Programmable Gate Array (FPGA), as only examples, which execute (processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents. As further examples of available embodiments included herein, the inventors hereby incorporate by reference the disclosure of their article titled “Ultra-Low Power Audio System for Portable Device”, presented at the 130th Audio Engineering Society Convention, May 13-16, 2011, London, UK.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A system for decoding audio data, comprising:
a subsystem including at least one input buffer to receive and store compressed audio data and an audio decoding unit to decode the stored compressed audio data, as decoded audio data; and
a top system, distinct from the subsystem, to selectively transmit the compressed audio data to the subsystem based upon management of a power management mode of the top system, with the management of the power management mode of the top system being dependent on operation of the subsystem.

2. The system of claim 1, further comprising:
an audio codec unit to convert pulse code modulation (PCM) data generated by the audio decoding unit, as the decoded audio data, to an audio output signal, and to output the audio output signal.

3. The system of claim 1, wherein the decoded audio data is decoded multi-channel audio data.

4. The system of claim 1, further comprising:
a data state storage unit to store data processing state information of one or more of the top system and the audio decoding unit.

5. The system of claim 4, wherein the data processing state information of the top system corresponds to the power management mode of the top system or represents that the top system will soon change the power management mode of the top system, and
wherein the operation of the subsystem is based on the data processing state information of the top system.

6. The system of claim 5, wherein the data processing state information of the top system is state information representing that the top system has begun or is transmitting the compressed audio data to the at least one input buffer or that the top system has completed transmitting the compressed audio data to the at least one input buffer.

7. The system of claim 4, wherein the data processing state information of the top system is state information representing that the top system has begun or is transmitting the compressed audio data to the at least one input buffer or that the top system has completed transmitting the compressed audio data to the at least one input buffer, and
wherein the operation of the subsystem is based on the data processing state information of the top system.

8. The system of claim 4, wherein the data processing state information of the audio decoding unit corresponds to a power management mode of the audio decoding unit or represents that the audio decoding unit will soon change the power management mode of the audio decoding unit, and
wherein the management of the power management mode of the top system is based on the data processing state information of the audio decoding unit.

9. The system of claim 8, wherein the data processing state information of the audio decoding unit is state information representing that the audio decoding unit has begun or is decoding the stored compressed audio data, that the audio decoding unit has completed decoding the stored compressed audio data, that the audio decoding unit has completed an outputting of the decoded audio data to an output buffer for provision of the decoded audio data to an audio codec unit, or that the audio codec unit has converted a predetermined amount of the decoded audio data.

10. The system of claim 4, wherein the data processing state information of the audio decoding unit is state information representing that the audio decoding unit has begun or is decoding the stored compressed audio data, that the audio decoding unit has completed decoding the stored compressed audio data, that the audio decoding unit has completed an outputting of the decoded audio data to an output buffer for provision of the decoded audio data to an audio codec unit, or that the audio codec unit has converted a predetermined amount of the decoded audio data, and
wherein the management of the power management mode of the top system is based on the data processing state information of the audio decoding unit.

11. The system of claim 4, wherein the data state storage unit stores data processing state information of the at least one input buffer.

12. The system of claim 11, wherein the data processing state information of the at least one input buffer corresponds to a power management mode of the at least one input buffer or represents that the at least one input buffer will soon change the power management mode of the at least one input buffer, and
wherein the management of the power management mode of the top system is based on the data processing state information of the at least one input buffer.

13. The system of claim 12, wherein the data processing state information of the at least one input buffer is state information representing that the at least one input buffer is not available to receive the compressed audio data from the top system or that the at least one input buffer is empty or ready to receive the compressed audio data from the top system.

14. The system of claim 11, wherein the data processing state information of the at least one input buffer is state information representing that the at least one input buffer is not available to receive the compressed audio data from the top system or that the at least one input buffer is empty or ready to receive the compressed audio data from the top system, and
wherein the management of the power management mode of the top system is based on the data processing state information of the at least one input buffer.

15. The system of claim 4, wherein, when the top system completes transmission of the compressed audio data to the at least one input buffer, the top system or the audio decoding unit stores a corresponding indicator of the completion in the data state storage unit, and the power management mode of the top system is switched to a reduced power mode.

16. The system of claim 4, wherein, when a transmission of the stored compressed audio data to the audio decoding unit from the at least one input buffer is complete, the audio decoding unit or the at least one input buffer stores a corresponding indicator of the completion in the data state storage unit, and the power management mode of the top system is switched to a full power mode.

17. The system of claim 2, wherein:
when a predetermined amount of the PCM data is converted to the audio output signal, the audio decoding unit stores, in the data state storage unit, information regarding whether residual compressed audio data is present in the at least one audio input buffer, and
when no residual compressed audio data exists in the at least one audio input buffer, the power management mode of the top system is switched to a full power mode.

18. The system of claim 17, wherein, when the predetermined amount of the PCM data is converted to the audio output signal and the power management mode of the top system is switched to the full power mode, the top system transmits new compressed audio data to the at least one audio input buffer.

19. The system of claim 2, further comprising:
at least one audio output buffer to store the PCM data and for transmission of the PCM data to the audio codec unit.

20. The system of claim 1, wherein, when the at least one audio input buffer includes a first audio input buffer and a second audio input buffer, the subsystem controls second compressed audio data stored in the second audio input buffer to be transferred to the audio decoding unit when the audio decoding unit completes decoding of first compressed audio data stored in the first audio input buffer.

21. The system of claim 20, wherein, when the second compressed audio data stored in the second audio input buffer is controlled to be transferred to the audio decoding unit, the top system is controlled to transfer new first compressed audio data to the first audio input buffer.

22. The system of claim 1, wherein the top system comprises:
a memory to store the compressed audio data; and
a direct memory access (DMA) to transfer the compressed audio data to the at least one audio input buffer through a bus.

23. The system of claim 22, wherein the top system further comprises a central processing unit (CPU).

24. The system of claim 1, wherein the system includes a system on a chip (SOC), including the top system and the subsystem, with the top system including at least one processor and the subsystem being a digital signal processor (DSP).

25. A system for decoding audio data, comprising
a subsystem including at least one input buffer to receive and store compressed audio data and an audio decoding unit to decode the stored compressed audio data, as decoded audio data; and
a top system to receive a transmission request of compressed audio data, and to selectively transmit the compressed audio data to the at least one input buffer,
wherein at least one power mode of the top system, controlling of the selective transmission of the compressed audio data, is selectively controlled to be in a power off mode while the audio decoding unit decodes the stored compressed audio data.

26. The system of claim 25, wherein the top system is in the power off mode during the decoding of the stored compressed audio data and does not change to a full power mode until the decoding of the stored compressed audio data is complete or the at least one input buffer is empty or indicative of being ready to receive and store additional compressed audio data.

27. The system of claim 25, wherein the top system enters the power off mode immediately after sending an interrupt instruction to the audio decoding unit when transmission of the compressed audio data to the at least one input buffer is complete.

28. The system of claim 25, further comprising:
a data state storage unit to store data processing state information of one or more of the top system and the audio decoding unit.

29. The system of claim 28, wherein, when the top system completes transmission of the compressed audio data to the at least one input buffer, the top system or the audio decoding unit stores a corresponding indicator of the completion in the data state storage unit, and the controlling of the at least one power mode of the top system controls the at least one power mode to be switched to the power off mode.

30. The system of claim 28, wherein, when a transmission of the stored compressed audio data to the audio decoding unit from the at least one input buffer is complete, the audio decoding unit or the at least one input buffer stores a corresponding indicator of the completion in the data state storage unit, and the controlling of the at least one power mode of the top system controls the at least one power mode to be switched to a full power mode.

31. The system of claim 25, further comprising:
the audio decoding unit decoding the compressed audio data to pulse code modulation (PCM) data; and
an audio codec unit to convert the PCM data to an audio output signal, and to output the audio output signal.

32. The system of claim 31, wherein:
when a predetermined amount of the PCM data is converted to the audio output signal, the audio decoding unit stores, in the data state storage unit, information regarding whether residual compressed audio data is present in the at least one audio input buffer, and
when no residual compressed audio data exists in the at least one audio input buffer, the controlling of the at least one power mode of the top system controls the at least one power mode to be switched to a full power mode.

33. The system of claim 32, wherein when the predetermined amount of the PCM data is converted to the audio output signal and the at least one power mode of the top system is controlled to be switched to the full power mode, the top system transmits new compressed audio data to the at least one audio input buffer.

34. The system of claim 25, wherein, when the at least one input buffer includes a first input buffer and a second input buffer, the at least one power mode of the top system is controlled to be at a full power mode while transferring new compressed audio data to the second input buffer and while the audio decoding unit is decoding stored compressed audio data from the first input buffer, such that the at least one power mode of the top system is switched to the power off mode upon completion of the transferring of the new compressed audio data to the second input buffer while the audio decoding unit is decoding either of the stored compressed audio data from the first input buffer or the new compressed audio data stored in the second input buffer.

35. The system of claim 25, wherein the system includes a system on a chip (SOC), including the top system and the subsystem, with the top system including at least one processor and the subsystem being a digital signal processor (DSP).

36. The system of claim 25, wherein the at least one power mode of the top system is selectively controlled to be one of plural available power management modes, including a sleep mode where the top system is in a ‘power off’ state, a deep idle and deep stop mode where the top system is in a ‘power off with L2 retention’ state, an idle and stop mode where the top system is maintained in a ‘standby’ state, and a normal mode where the top system is in a ‘run’ or ‘full power’ state, and
wherein the at least one power mode of the top system is selectively controlled be in one of the deep idle and deep stop mode in the power off mode and in the normal mode in a full power mode.

37. A system for decoding audio data, comprising
a subsystem including at least one input buffer to receive and store compressed audio data from a top system, distinct from the subsystem, and an audio decoding unit to decode the stored compressed audio data, as decoded audio data,
wherein the subsystem controls the top system to selectively transmit the compressed audio data to the at least one input buffer and controls at least one power mode of the top system, controlling of the selective transmission of the compressed audio data, to be in a power off mode while the audio decoding unit decodes the stored compressed audio data.

38. The system of claim 37, wherein the subsystem controls the top system to be in the power off mode during the decoding of the stored compressed audio data and controls the top system to not change to a full power mode until the decoding of the stored compressed audio data is complete or the at least one input buffer is empty or indicative of being ready to receive and store additional compressed audio data.

39. The system of claim 37, wherein the subsystem controls the top system to enter the power off mode when transmission of the compressed audio data by the top system to the at least one input buffer is complete.

40. The system of claim 37, further comprising:
a data state storage unit to store data processing state information of one or more of the at least one input buffer and the audio decoding unit.

41. The system of claim 40, wherein, when the top system completes transmission of the compressed audio data to the at least one input buffer, the audio decoding unit stores a corresponding indicator of the completion in the data state storage unit, and the controlling of the at least one power mode of the top system controls the at least one power mode to be switched to the power off mode.

42. The system of claim 40, wherein, when a transmission of the stored compressed audio data to the audio decoding unit from the at least one input buffer is complete, the audio decoding unit or the at least one input buffer stores a corresponding indicator of the completion in the data state storage unit, and the controlling of the at least one power mode of the top system controls the at least one power mode to be switched to a full power mode.

43. The system of claim 40, wherein the subsystem controls the top system based on the data processing state information in the data state storage unit.

44. The system of claim 37, wherein the at least one power mode of the top system is selectively controlled to be one of plural available power management modes, including a sleep mode where the top system is in a ‘power off’ state, a deep idle and deep stop mode where the top system is in a ‘power off with L2 retention’ state, an idle and stop mode where the top system is maintained in a ‘standby’ state, and a normal mode where the top system is in a ‘run’ or ‘full power’ state, and
wherein the at least one power mode of the top system is selectively controlled be in one of the deep idle and deep stop mode in the power off mode and in the normal mode in a full power mode.

45. The system of claim 37, further comprising transmitting an interrupt instruction to the top system when a transmission of the stored compressed audio data to the audio decoding unit from the at least one input buffer is complete or the at least one input buffer is indicative of being reading to receive new compressed audio data.

46. The system of claim 37, wherein the system includes a system on a chip (SOC), including the top system and the subsystem, with the top system including at least one processor and the subsystem being a digital signal processor (DSP).

47. The system of claim 37, wherein the subsystem is a digital signal processor (DSP).

48. A method of decoding audio data, comprising:
receiving compressed audio data from a separately provided top system, and storing the compressed audio data in at least one audio input buffer;
decoding the stored compressed audio data of the at least one audio input buffer using an audio decoding unit separate from the top system, as decoded audio data; and
managing a power management mode of the top system to selectively transmit the compressed audio data, with the management of the power management mode of the top system being dependent on the storing of the compressed audio data and the decoding of the stored compressed audio data.

49. The method of claim 48, further comprising:
converting, using an audio codec unit separate from the top system, PCM data of the decoded audio data to an audio output signal, and outputting the converted audio output signal.

50. The method of claim 48, further comprising:
selectively storing data processing state information of one or more of the top system and the audio decoding, and controlling the top system to be switched to a power off mode when transmission of the compressed audio data to the audio decoding unit is completed.

51. The method of claim 50, further comprising:
storing information regarding whether residual compressed audio data exists in the at least one audio input buffer when a predetermined amount of PCM data of the decoded audio data is converted by a codec to an audio output signal; and
controlling the top system to be switched to a full power mode based upon a determination that the at least one audio input buffer does not include the residual compressed audio data.

52. The method of claim 51, further comprising:
storing new compressed audio data in the at least one audio input buffer when the predetermined amount of the PCM data is converted to the audio output signal and the top system is switched to the full power mode.

53. The method of claim 52, further comprising:
controlling compressed audio data stored in a second audio input buffer to be transferred to the audio decoding unit when all of the compressed audio data stored in a first audio input buffer is transferred to the audio decoding unit and is decoded to the decoded audio data.

54. The method of claim 53, further comprising:
transmitting the new compressed audio data from the top system to the first audio input buffer when the compressed audio data stored in the second audio input buffer is transferred to the audio decoding unit.

55. The method of claim 48, further comprising:
selectively storing data processing state information of one or more of the top system and the audio decoding.

56. The method of claim 55, wherein the data processing state information of the top system corresponds to the power management mode of the top system or represents that the top system will soon change the power management mode of the top system, and
wherein the storing of the compressed audio data and/or the decoding of the stored compressed audio data is based on the data processing state information of the top system.

57. The method of claim 56, wherein the data processing state information of the top system is state information representing that the top system has begun or is transmitting the compressed audio data to the at least one input buffer or that the top system has completed transmitting the compressed audio data to the at least one input buffer.

58. The method of claim 55, wherein the data processing state information of the top system is state information representing that the top system has begun or is transmitting the compressed audio data to the at least one input buffer or that the top system has completed transmitting the compressed audio data to the at least one input buffer, and
wherein the storing of the compressed audio data and/or the decoding of the stored compressed audio data is based on the data processing state information of the top system.

59. The method of claim 55, wherein the data processing state information of the audio decoding unit corresponds to a power management mode of the audio decoding unit or represents that the audio decoding unit will soon change the power management mode of the audio decoding unit, and
wherein the management of the power management mode of the top system is based on the data processing state information of the audio decoding unit.

60. The method of claim 59, wherein the data processing state information of the audio decoding unit is state information representing that the audio decoding unit has begun or is decoding the stored compressed audio data, that the audio decoding unit has completed decoding the stored compressed audio data, that the audio decoding unit has completed an outputting of the decoded audio data to an output buffer for provision of the decoded audio data to an audio codec unit, or that the audio codec unit has converted a predetermined amount of the decoded audio data.

61. The method of claim 55, wherein the data processing state information of the audio decoding unit is state information representing that the audio decoding unit has begun or is decoding the stored compressed audio data, that the audio decoding unit has completed decoding the stored compressed audio data, that the audio decoding unit has completed an outputting of the decoded audio data to an output buffer for provision of the decoded audio data to an audio codec unit, or that the audio codec unit has converted a predetermined amount of the decoded audio data, and
wherein the management of the power management mode of the top system is based on the data processing state information of the audio decoding unit.

62. The method of claim 55, wherein the data state storage unit stores data processing state information of the at least one input buffer.

63. The method of claim 52, wherein the data processing state information of the at least one input buffer corresponds to a power management mode of the at least one input buffer or represents that the at least one input buffer will soon change the power management mode of the at least one input buffer, and
wherein the management of the power management mode of the top system is based on the data processing state information of the at least one input buffer.

64. The method of claim 53, wherein the data processing state information is state information representing that the at least one input buffer is not available to receive the compressed audio data from the top system or that the at least one input buffer is empty or ready to receive the compressed audio data from the top system.

65. The method of claim 62, wherein the data processing state information is state information representing that the at least one input buffer is not available to receive the compressed audio data from the top system or that the at least one input buffer is empty or ready to receive the compressed audio data from the top system, and
wherein the management of the power management mode of the top system is based on the data processing state information of the at least one input buffer.

66. A non-transitory computer-readable medium comprising computer readable code to control at least one processing device to implement the method of claim 48.

67. A method for decoding audio data, comprising
receiving compressed audio data from a separately provided top system, and storing the compressed audio data in at least one audio input buffer;
decoding the stored compressed audio data of the at least one audio input buffer using an audio decoding unit separate from the top system, as decoded audio data; and
controlling at least one power mode of the top system, controlling of a selective transmission of the compressed audio data to the at least one audio input buffer, to be in a power off mode while the audio decoding unit is decoding the stored compressed audio data.

68. The method of claim 67, wherein the at least one power mode of the top system is controlled to be in the power off mode during the decoding of the stored compressed audio data and does not change to a full power mode until the decoding of the stored compressed audio data is complete or the at least one input buffer is empty or indicative of being ready to receive and store additional compressed audio data.

69. The method of claim 67, wherein the top system enters a power off mode immediately after sending an interrupt instruction to the audio decoding unit when transmission of the compressed audio data to the at least one input buffer is complete.

70. The method of claim 67, further comprising sending an interrupt instruction to the top system upon the decoding of the stored compressed audio data being complete.

71. The method of claim 67, wherein the at least one power mode of the top system is selectively controlled to be one of plural available power management modes, including a sleep mode where the top system is in a ‘power off’ state, a deep idle and deep stop mode where the top system is in a ‘power off with L2 retention’ state, an idle and stop mode where the top system is maintained in a ‘standby’ state, and a normal mode where the top system is in a ‘run’ or ‘full power’ state, and
wherein the at least one power mode of the top system is selectively controlled be in one of the deep idle and deep stop mode in the power off mode and in the normal mode in a full power mode.

72. A non-transitory computer-readable medium comprising computer readable code to control at least one processing device to implement the method of claim 67.
